(19) United States
(12) Patent Application Publication
(10) Pub. No.: US 2010/0200361 A1
(43) Pub. Date: Aug. 12, 2010

(54) ELEVATOR MECHANICAL TIMING CONNECTION FREE AUTOMATIC SYSTEM FOR IMMERSION PROCESSING VEHICLE BODYWORKS

(75) Inventor: Mauro Tagliavento, Cinisello Balsamo(Mi) (IT)

Correspondence Address: HEDMAN & COSTIGAN, P.C., 1230 AVENUE OF THE AMERICAS, 7th floor, NEW YORK, NY, 10020, US

(73) Assignee: GEICO S.p.A., Cinisello Balsamo (IT)

(21) Appl. No.: 12/733,413

(22) PCT Filed: Jul. 4, 2008
(86) PCT No.: PCT/IT2008/000450

§ 371 Date: Apr. 9, 2010

(30) Foreign Application Priority Data
Aug. 30, 2007 (IT) MI2007A 001705

(51) Int. Cl. B05C 3/02; B65G 37/00; B65G 49/04; B62D 65/18

(52) U.S. Cl. 198/346.3

(57) ABSTRACT

An elevator mechanical timing connection free automatic system for immersion processing vehicle bodyworks comprises a plurality of modular processing basins (6) with four lowering devices (13-15) for each basin, operated by independent motors coupled, by pairs, to an electric control system for holding in a timed relationship the raising and lowering movement of pairs of pendulum elements (15), of an independent movement type, thereon a skid-bodywork assembly (1, 5) is loaded.

### BACKGROUND OF THE INVENTION

The present invention relates to an elevator mechanical timing connection free automatic system for immersion processing vehicle bodyworks.

As is known, in automatic systems for immersion processing vehicle bodyworks, a skid assembly, to which is coupled the vehicle bodywork to be processed, is conventionally used.

Said skid assembly is conveyed to a plurality of different working stations and is so constructed as to be engaged by gripping structures for introducing said skid assembly and related vehicle bodywork into processing basins.

Conventional systems for handling vehicle bodyworks, and in particular the mechanisms for introducing the vehicle bodyworks into the processing basins, have the drawback that they are very complex from a construction and assembling standpoint.

### SUMMARY OF THE INVENTION

Thus, the aim of the present invention is to provide such an automatic system for immersion processing civil and industrial vehicle bodyworks, which does not comprise mechanical connections for timing or operatively synchronizing the elevator assemblies of the system.

Within the scope of the above mentioned aim, a main object of the invention is to provide such an automatic system for handling vehicle bodyworks, which is adapted to perfectly meet all the bodywork processing requirements, and which, moreover, also contributes to providing a very great reduction of the operating cost.

Another object of the invention is to provide such a system which is very simple construction-wise and which, moreover, is very competitive from a mere economic standpoint.

Yet another object of the present invention is to provide such a system which, owing to its peculiar constructional features, is very reliable and safe in operation.

According to one aspect of the present invention, the above mentioned aim and objects, as well as yet other objects, which will become more apparent hereinafter, are achieved by an elevator mechanical timing connection free automatic system for immersion processing vehicle bodyworks, characterized in that said system comprises a roller conveyor system thereon a skid is conveyed, said skid supporting a vehicle bodywork or the like.

Said conveyor system affects at least a processing basin where operates a vertical translating or driving system for immersing the vehicle bodywork into said processing basin, said vertical driving system comprising four lowering devices including independent motors, coupled by pairs by an electric control system for holding a timed motion for raising and lowering respective pendulum elements pairs, of an independent driven type, thereon a skid-vehicle bodywork assembly is loaded.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative, but not limitative, example in the accompanying drawings, where:

FIG. 1 is a schematic perspective view showing the system according to the present invention;

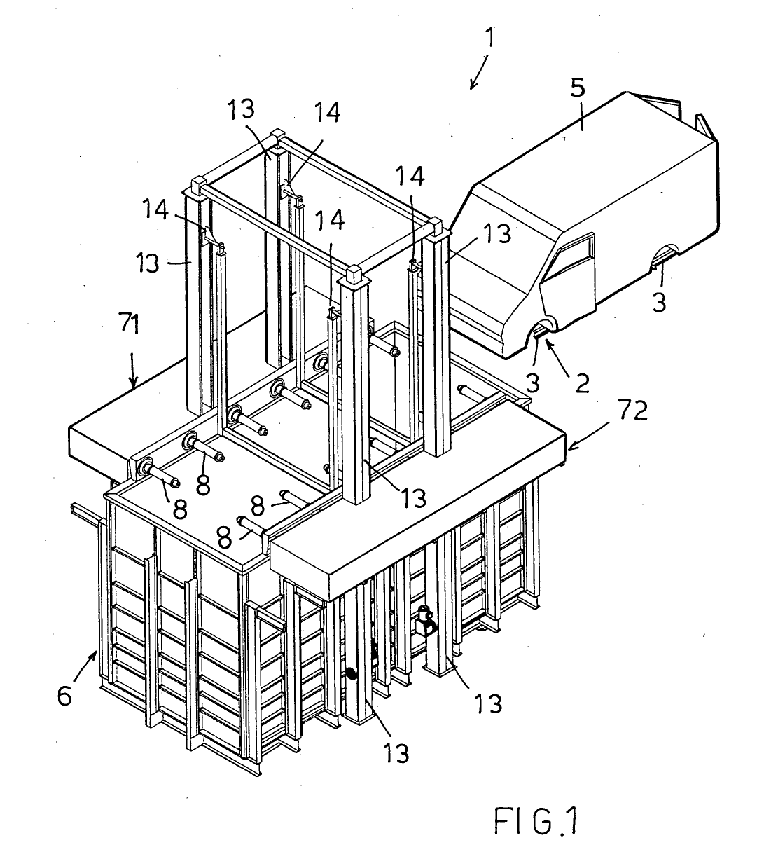

FIG. 2 is a front elevation view, as partially cross-sectioned, of the system;

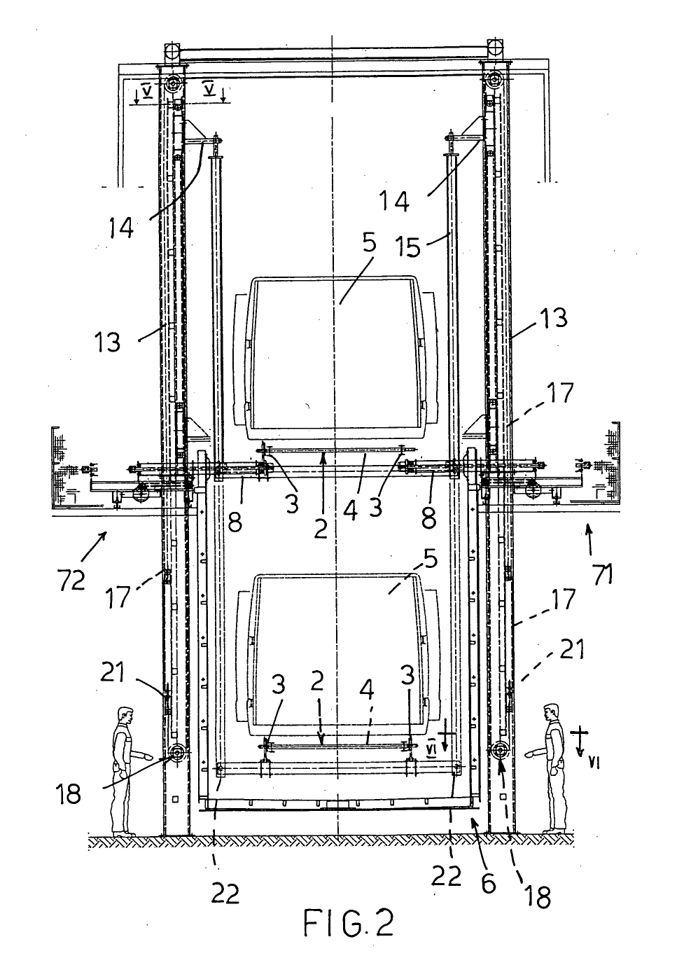

FIG. 3 is a top plan view of the pair of roller processing beds for transferring a skid+vehicle bodywork system or assembly, from a processing basin to another processing basin;

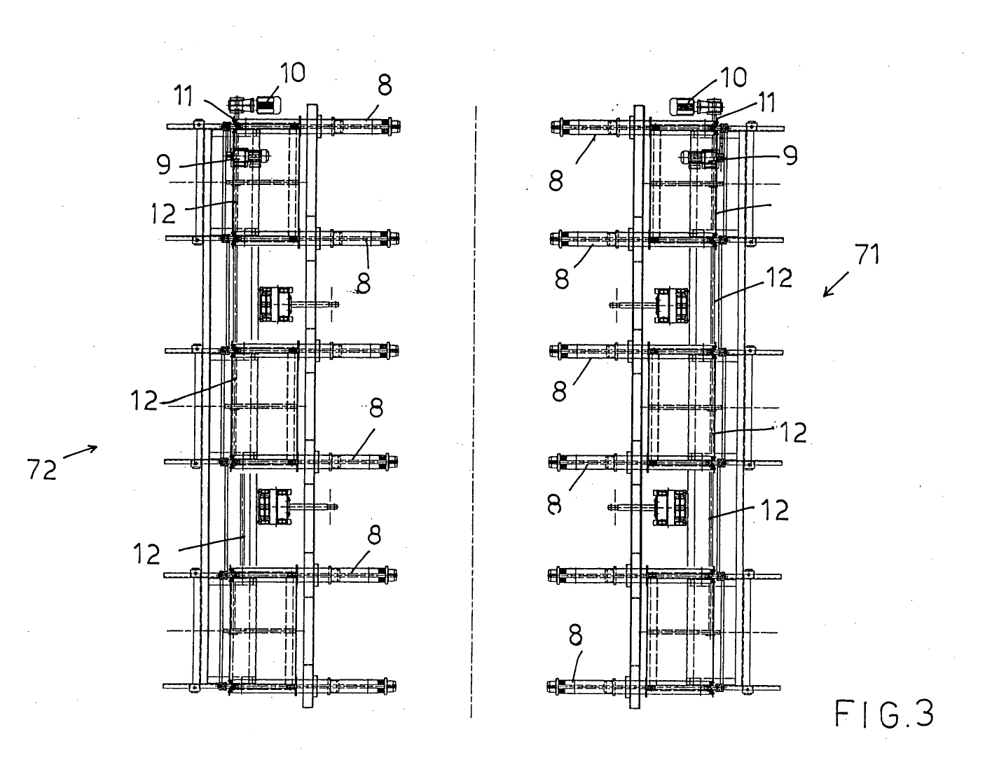

FIG. 4 is a front elevation view of the processing bed pair;

FIG. 5 is a top plan view, as cross-sectioned through the cross-section plane V-V of FIG. 2, showing an elevator or raising device;

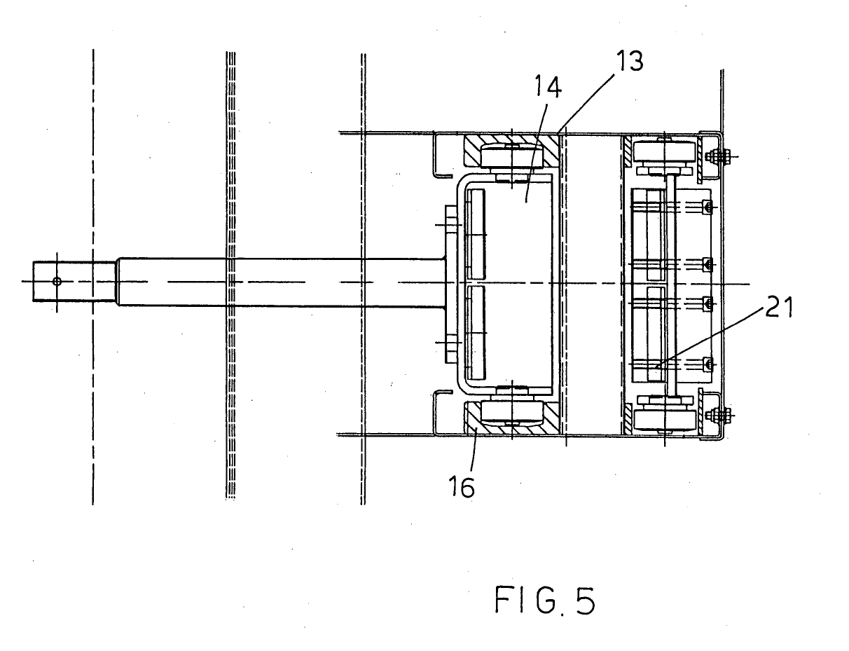

FIG. 6 is a further top plan view, as cross-sectioned though the cross-section plane VI-VI of FIG. 2, showing the elevator or raising device; and

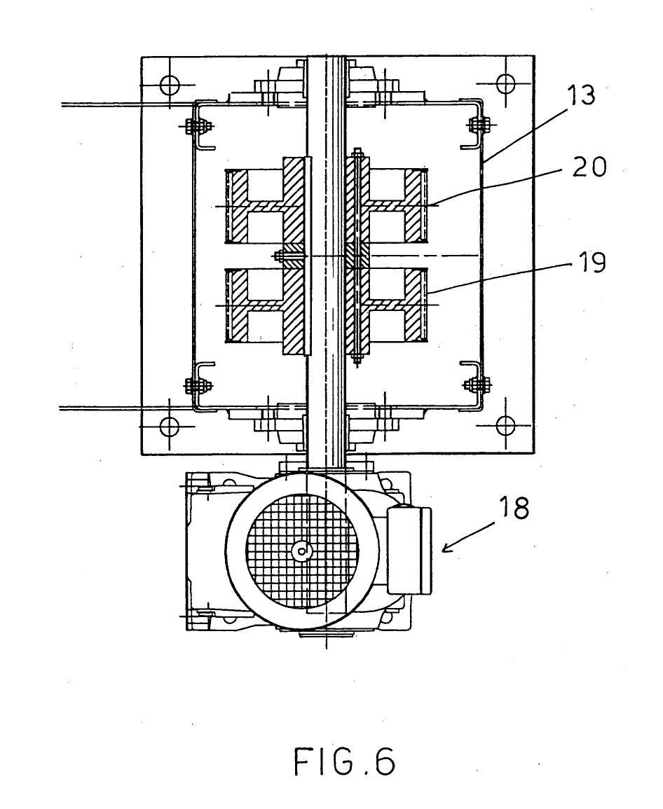

FIG. 7 shows a modified embodiment of the upright 13, having a slot arranged on the outside of the lowering device and a connection with a pendulum element through a ring pivot bearing construction.

### DESCRIPTION OF THE PREFERRED EMBODIMENTS

With reference to the number references of the above mentioned figures, the automatic system according to the present invention, which has been generally indicated by the reference number 1, comprises, in a per se-known manner, a roller conveyor system, thereon is conveyed a skid 2 including a plurality of longitudinal elements 3, coupled by cross elements 4.

More specifically, the longitudinal elements 3 are conveyed on the rollers so as to cause the skid, thereon the vehicle bodywork 5 is supported, to be conveyed to each processing basin.

In the figures a processing basin indicated by the reference number 6 is shown.

As known, in said processing basins are successively performed a plurality of processing operations such as pickling washing, actuating, phosphatizing, water post-washing, using water or demineralized water washing operations, as well as painting basins, followed by further washing basins.

The inventive system provides to use a variable number of basins 6, and allows to change the production yield of the system, with a further possibility of further changing said production yield at any desired time, included after a first installation and/or use of the system.

To improve the production yield, actually, it is merely sufficient to change, or increase, the number of the processing basins.

The system, in particular, is so designed as to allows to convey different types of vehicle bodyworks to be processed, and to also allow to perform different processing operations, depending on the materials the vehicle bodyworks are made of.

More specifically, the roller conveyor system comprises a pair of conveyor beds, respectively a right and a left conveyor bed, generally indicated by the reference numbers 71 and 72 and including separated driving assemblies for rotatively driving the rollers 8 and cross driving or displacing said conveyor beds.

The conveyor system will provide, at a projecting position, a transfer or the skid and vehicle bodywork system or assembly from a processing basin to another processing basin.

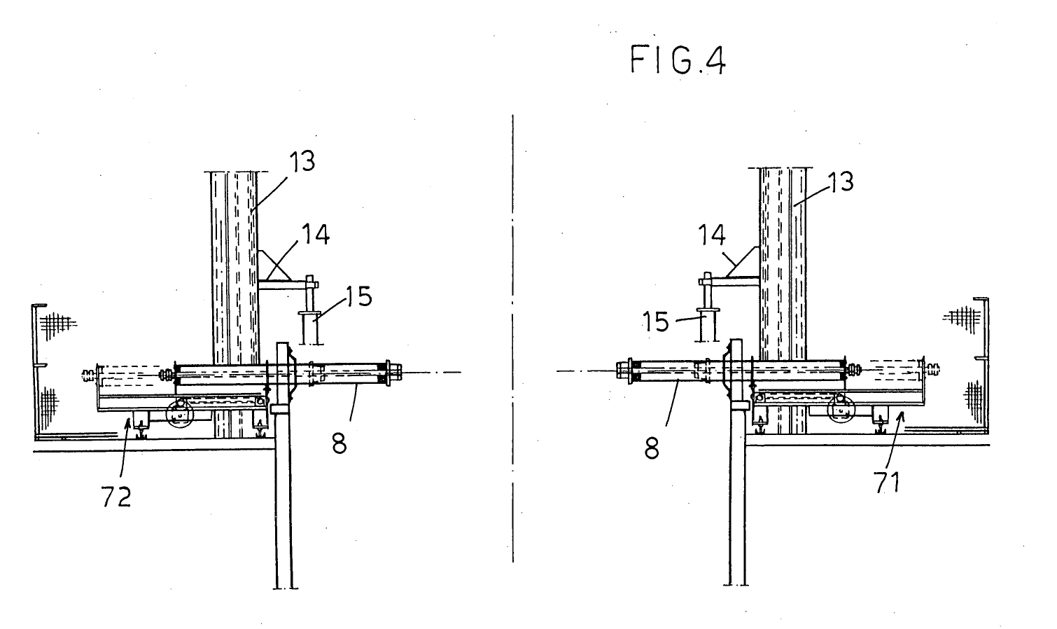

At a withdrawn position thereof, as schematically shown by dashed lines in FIG. 4, the roller beds will provide a vertical displacement or driving of the skid+bodywork system or assembly for immersing this assembly into a respective said processing basin.

The roller beds are driven by driving chains 12, arranged in a tandem relationship, and driven by an inverter controlled motor 9, for rotatively driving said rollers 8, and by a screw system 11, with a separated geared motor unit 10, for cross driving the roller beds.

Moreover, the system according to the present invention further comprises, for each said processing basin 6, a vertical driving system for immersing the vehicle bodywork into said processing basin.

Said vertical driving system comprises four lowering devices, for each processing basin, with independent motors, coupled, by pairs by an electric control system for providing a continuously timed relationship of the raising and lowering movements of respective pairs of pendulum elements, of an independently driven type, thereon the skid-vehicle bodywork system or assembly is loaded.

More specifically, the vertical driving or translating system comprises four uprights 13, each of which comprises in turn an elevator or lifting device including a carriage 14 thereon an end portion of a pendulum element 15 is pivoted.

The translation system comprises two pendulum elements 15 supporting the skid 2 during the lowering and raising vertical movement thereof.

Each carriage 14 can slide on a respective sliding guide 16 of a respective upright 13 and is rigidly or integrally coupled with a toothed belt 17, driven by an inverter controlled geared unit 18, including a transmission pulley 19.

In each elevator or raising device, a second belt revolution, transmitted through a second pulley 20 of the geared motor unit, will assure a safety condition in a case of a failure or wearing of the operating belt.

Each elevator or raising device comprises, moreover, a counterweight 21.

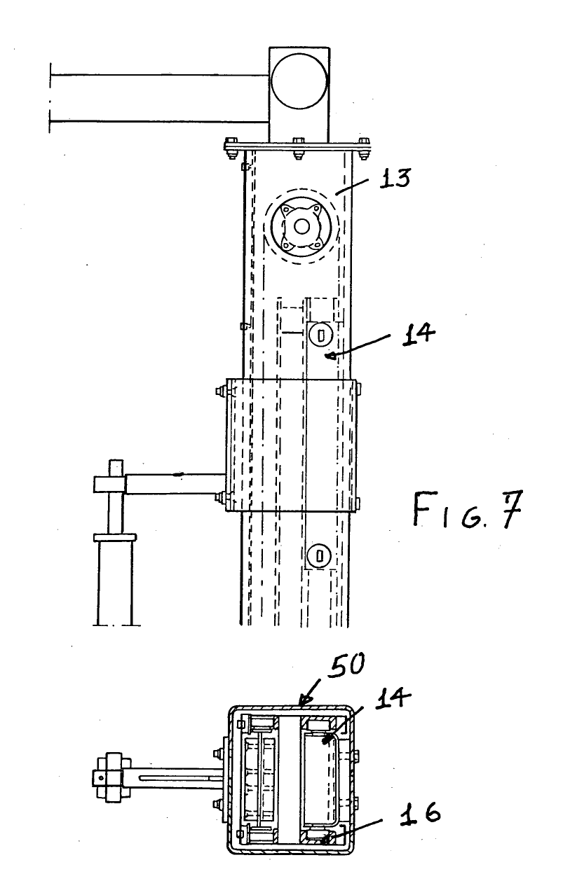

For preventing liquids from entering the slot of the pendulum holder pivot pin 14, a specific embodiment of the invention provides to include a spray region for the upright construction 13 with a slot arranged on an outer side of the lowering device and with a connection to the pendulum element through a ring pivot holder construction, as is shown in FIG. 7.

This embodiment, which has been designed for the spray regions, can be advantageously used for providing a proper cleaning even in mixed regions of spraying-immersion or exclusively immersion.

To compensate for possible small displacement or stroke differences of the elevator or lifting devices (respectively a right and left lifting device) coupled by an electric control system, the pendulum element 15 comprises hinge assemblies 22, on the bottom cross element, to prevent undesired forces and torques from being transmitted to the pivot pins of the pendulum element.

The operation of the system is such that, as a vehicle bodywork 5 is arranged at a respective processing basin 6, then the pendulum element 15 will take-in or grip the skid, by raising it from the rollers 8, which can correspondingly axially translate thereby releasing the end top portion of the processing basin, with a following lowering of the pendulum elements into said processing basin.

During this operating step, the pendulum element pairs can be caused to descend in a different manner to provide a series of swinging movements of the skid, allowing the vehicle bodywork to be introduced into the processing basin with a slanted attitude and for allowing the ejection of possible air bubbles susceptible to accumulate inside the box-like bodies and top walls of the vehicle bodyworks.

Thus, is assured a perfect processing of the boxed inner surfaces of the bodyworks, while eliminating air bubbles which could hinder a proper adhesion of the product being applied during the processing operations.

With the pendulum element at a lowered position, it is possible to relocate the rollers 8 thereby allowing a skid to be properly driven over the processing basin.

Depending on the size requirements of the workpieces to be processed, the heights of the lowering devices and vertical displacements or strokes thereof can be changed depending on requirements, and, moreover, the roller beds can be designed to include variable pitch rollers, depending on the skid length.

It has been found that the invention fully achieves the intended aim and objects.

In fact, the invention provides an automatic system for immersion-processing civil and industrial vehicle bodyworks, which system does not include mechanical connections for timing the operations of the individual elevators.

In practicing the invention, the used materials, as well as the contingent size and shapes, can be any, depending on requirements.

1. An elevator mechanical-timing-connection-free automatic system for immersing processing civil and industrial vehicle bodyworks into a variable number of processing basins for processing said vehicle bodyworks, characterized in that said system comprises a roller conveyor system, thereon a skid is conveyed, said skid being adapted to support said vehicle bodyworks and to convey said vehicle bodyworks to said processing basins where operates a vertical translating system for immersing said vehicle bodyworks into said processing basins, said vertical translating or driving system comprising for each said processing basin four lowering devices with independent motors, coupled, by pairs, to an electric control system for providing a continuous timing of raising and lowering movements of independently driven respective pendulum element pairs thereon a skid-motor vehicle bodywork assembly is loaded.

2. An automatic system, according to claim 1, characterized in that said roller conveyor system comprises a pair of roller bed having separated driving means for rotatively driving said rollers and cross displacing said roller beds, said roller beds including at least an extended conveyor position and a withdrawn position for allowing said rollers to vertically drive said skid-motor vehicle bodywork assembly for immersing said assembly into a respective processing basin.

3. An automatic system, according to claim 1, characterized in that said bed rollers are operatively driven by tandem chains, in turn driven by an inverter controlled motor, for rotatively driving said rollers and further including a screw system with a separated geared motor unit for transversely driving said roller bed.

4. An automatic system, according to claim 1, characterized in that said vertical driving or translating system comprises four uprights each including a respective elevator or raising device including a carriage to which an end portion of a pendulum element of said pendulum element pairs is pivoted, either directly or through a ring connection construction.

5. An automatic system, according to claim 1, characterized in that said driving or translating system comprises two pendulum elements supporting said skid during a vertical lowering and raising movement thereof.

6. An automatic system, according to claim 1, characterized in that each carriage of said vertical driving or translating system is designed for sliding on a sliding guide of a respective upright and being rigidly coupled to a toothed belt driven by an inverter controlled motor geared unit, including a transmission pulley.

7. An automatic system, according to claim 4, characterized in that in each said elevator device a second belt revolution, backward transmitted through a second motor geared unit pulley, provides a safety condition for compensating for a failure or wear of said belt.

8. An automatic system, according to claim 4, characterized in that each said elevator device comprises a counterweight.

9. An automatic system, according to claim 1, characterized in that, each pendulum element of said pendulum element pairs comprises bottom hinge assemblies to prevent undesired forces and torques from being transmitted to said pendulum element.

10. An automatic system, according to claims 1, characterized in that, said lowering devices have variable heights and operating vertical strokes, and said roller beds comprise a plurality of variable pitch rollers.

11. (canceled)
